(19) United States
(12) Patent Application Publication
(10) Pub. No.: US 2012/0001863 A1
(43) Pub. Date: Jan. 5, 2012

(54) TOUCH PANEL

(75) Inventors: Woon Chun Kim, Gyunggi-do (KR); Yong Soo Oh, Gyunggi-do (KR); Hee Bum Lee, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/884,526

(22) Filed: Sep. 17, 2010

(30) Foreign Application Priority Data
Jul. 2, 2010 (KR) 1020100064027

(51) Int. Cl. G06F 3/044; G06F 3/045

(52) U.S. Cl. 345/174; 178/18.06

(57) ABSTRACT

Disclosed herein is a touch panel, including: a transparent substrate including an active region and a bezel region partitioned thereon; a plurality of first transparent electrodes formed in the active region in parallel to each other along a Y-axis direction and including a plurality of first sensing units and a plurality of first connecting units connected with the plurality of first sensing units in an X-axis direction; a plurality of second transparent electrodes alternately formed with the plurality of first sensing units in the active region in parallel to each other along the Y-axis direction and including a plurality of second sensing units and a plurality of second connecting units connected with the plurality of first sensing units in the X-axis direction; and electrode wirings formed in the bezel region and connected to terminals of the first transparent electrodes and terminals of the second transparent electrodes, respectively.

### CROSS REFERENCE TO RELATED APPLICATION

This application claims the benefit of Korean Patent Application No. 10-2010-0064027, filed on Jul. 2, 2010, entitled “touch panel”, which is hereby incorporated by reference in its entirety into this application.

### BACKGROUND OF THE INVENTION

1. Technical Field

The present invention relates to a touch panel.

2. Description of the Related Art

Development of auxiliary computer devices has taken place alongside the advancement of computers which use digital technology. Personal computers, portable transmitters, and other personal information processing apparatuses carry out the processing of text and graphics using input devices such as keyboards, mice and the like.

However, since computers are gradually being used for various purposes alongside the rapid advance of the information society, there is a problem in that it is difficult to efficiently operate the computers using keyboards and mice which serve as input devices. Therefore, the demand to develop an input device which has a simple structure and does not cause erroneous operations and which can be used to easily input information and data by users is increasing.

Further, input devices must have high reliability, high durability, high innovativeness and high workability in addition to general functionality. In order to accomplish these purposes, a touch panel was developed as an input device capable of inputting information such as text, graphics and the like.

The touch panel is mounted on image display apparatuses, such as flat panel displays including electronic notebooks, liquid crystal displays (LCDs), plasma display panels (PDPs), electroluminescence panels, etc., and cathode ray tubes (CRTs), and is used to enable users to select desired information while viewing an image display apparatus.

Touch panels are classified into resistive touch panels, capacitive touch panels, electromagnetic touch panels, surface acoustic wave (SAW) type touch panels, and infrared touch panels. These various types of touch panels are employed in electronic products in consideration of the problem of signal amplification, the differences of resolution, the difficulty in design and machining techniques, optical characteristics, electrical characteristics, mechanical characteristics, environment-resistant characteristics, input characteristics, durability, and economical efficiency. Currently, among these touch panels, resistive touch panels and capacitive touch panels are the most widely used.

In the capacitive touch panels, two kinds of electrode patterns are formed. Here, one of the electrode patterns is formed in an X-axis direction, and the other of the electrode patterns is formed in a Y-axis direction, thus making a lattice structure. Further, the capacitance between the two kinds of electrode patterns is measured to calculate touch coordinates. The capacitive touch panel may be fabricated to have a two-layer structure on a substrate. In this case, since the electrode pattern formed in an X-axis direction and the electrode pattern formed in a Y-axis direction are disposed on different planes of a substrate, there is a problem in that the total thickness of the capacitive touch panel is increased.

In order to solve the above problem, a capacitive touch panel having a single layer structure was proposed. That is, in this capacitive touch panel, the electrode pattern formed in an X-axis direction and the electrode pattern formed in a Y-axis direction are disposed on the same plane of a substrate. In this case, since the electrode pattern formed in an X-axis direction and the electrode pattern formed in a Y-axis direction must not be electrically connected to each other, a bridge structure must be provided at intersection portions of the capacitive touch panel. Here, the bridge structure is a structure in which the electrode pattern formed in an X-axis direction is disposed under an insulation layer and the electrode pattern formed in a Y-axis direction is connected to the electrode pattern formed in an X-axis direction through bridges.

However, the bridge structure is problematic in that it is difficult to connect the electrode pattern formed in a Y-axis direction using bridges because an insulation layer thicker than the electrode pattern is used, and in that bridges are formed in a predetermined width or more, so that the bridges can be recognized by users, thereby deteriorating the visibility of the touch panel. Further, this bridge structure is problematic in that parasitic capacitance is generated between the bridges and the electrode pattern formed in an X-axis direction, so that it is difficult for users to recognize touch.

### SUMMARY OF THE INVENTION

Accordingly, the present invention has been devised to solve the above-mentioned problems, and the present invention provides a touch panel which can simplify the manufacturing process thereof, improve the visibility thereof and prevent the occurrence of noise by allowing first and second transparent electrodes to be flush with each other in parallel to omit bridges.

An aspect of the present invention provides a touch panel, including: a transparent substrate including an active region and a bezel region partitioned thereon; a plurality of first transparent electrodes formed in the active region in parallel to each other along a Y-axis direction and including a plurality of first sensing units and a plurality of first connecting units connected with the plurality of first sensing units in an X-axis direction; a plurality of second transparent electrodes alternately formed with the plurality of first sensing units in the active region in parallel to each other along the Y-axis direction and including a plurality of second sensing units and a plurality of second connecting units connected with the plurality of first sensing units in the X-axis direction; and electrode wirings formed in the bezel region and connected to terminals of the first transparent electrodes and terminals of the second transparent electrodes, respectively, wherein the coordinate of the center of the first connecting unit on the X-axis is identical with the coordinate of the center of the second sensing unit adjacent to the first connecting unit, and the coordinate of the center of the second connecting unit on the X-axis is identical with the coordinate of the center of the first sensing unit adjacent to the second connecting unit.

Here, the width of the first sensing unit and the width of the second sensing unit, which are taken along a Y-axis edge of the active region, may be equal to each other.

Further, the contact area between the terminal of the first transparent electrode and the electrode wiring may be equal to the contact area between the terminal of the second transparent electrode and the electrode wiring.

Further, the first sensing unit or the second sensing unit may have a diamond shape, an octagon shape or a circular shape.

Further, the first sensing unit may overlap with the second sensing unit adjacent to the first sensing unit base on the Y-axis direction.

Further, the first transparent electrode or the second transparent electrode may be made of a conductive polymer.

Further, the conductive polymer may include poly-3,4-ethylenedioxythiophene/polystyrenesulfonate (PEDOT/PSS), polyaniline, polyacetylene, and polyphenylenevinylene.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are perspective views showing touch panels according to preferred embodiment of the present invention; and

FIGS. 4 to 6 are plan views showing touch panels according to preferred embodiment of the present invention.

### DESCRIPTION OF THE PREFERRED EMBODIMENTS

The objects, features and advantages of the present invention will be more clearly understood from the following detailed description of preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

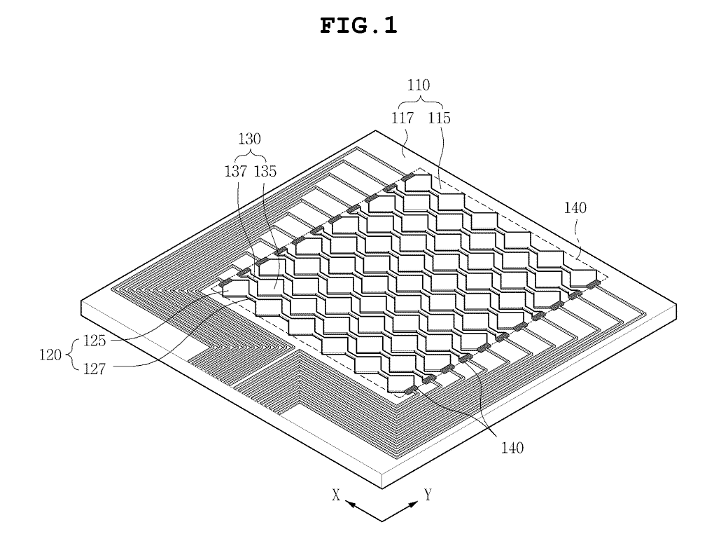

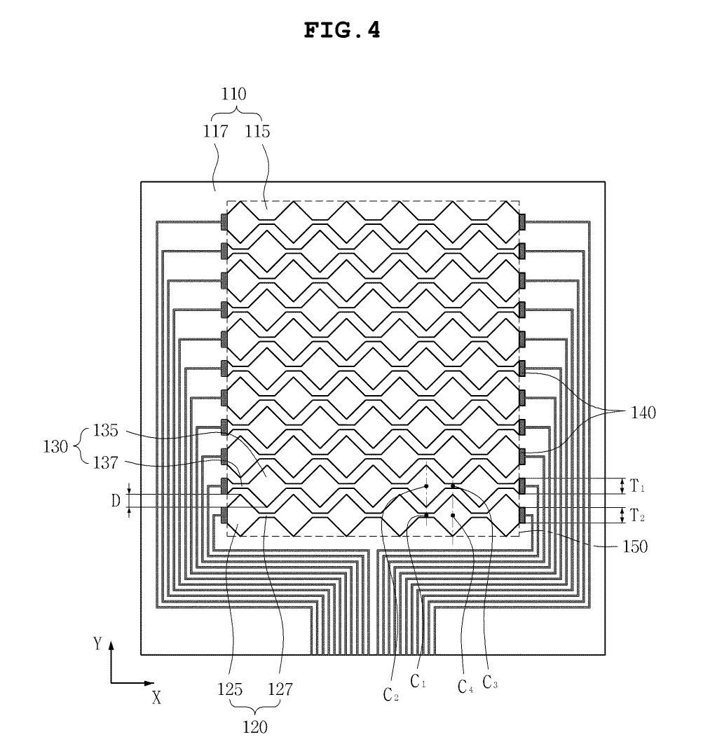

FIGS. 1 to 3 are perspective views showing touch panels according to preferred embodiment of the present invention, and FIGS. 4 to 6 are plan views showing touch panels according to preferred embodiment of the present invention.

As shown in FIGS. 1 to 6, the touch panel according to the present invention includes: a transparent substrate 110 including an active region 115 and a bezel region 117 partitioned thereon; a plurality of first transparent electrodes 120 formed in the active region 115 in parallel to each other along the Y-axis direction and including a plurality of first sensing units 125 and a plurality of first connecting units 127 connected with the plurality of first sensing units 125 in the X-axis direction; a plurality of second transparent electrodes 130 alternately formed with the plurality of first sensing units 125 in the active region 115 in parallel to each other along the Y-axis direction and including a plurality of second sensing units 135 and a plurality of second connecting units 137 connected with the plurality of first sensing units 135 in the X-axis direction; and electrode wirings 140 formed in the bezel region 117 and connected to the terminals of the first transparent electrodes 120 and the terminals of the second transparent electrodes 130, respectively.

The transparent substrate 110 is partitioned into the active region 115 and the bezel region 117. Here, the active region 115 is provided with the transparent electrodes (first transparent electrodes 120 and second transparent electrodes 130) and is disposed in the center of the transparent substrate 110, and bezel region 117 is provided with electrode wirings 140 electrically communicating with the transparent electrodes (first transparent electrodes 120 and second transparent electrodes 130) and is disposed at the edge of the active region 115. Here, the transparent film may be made of polyethylene terephthalate (PET), polycarbonate (PC), polymethylmethacrylate (PMMA), polyethylene naphthalate (PEN), polyether sulfone (PES), cycloolefin copolymer (COC), triacetylcellulose (TAC), polyvinyl alcohol (PVA), polyimide (PI), polystyrene (PS), K-resin-containing biaxially-oriented polystyrene (BOPS), glass, reinforced glass, or the like. Meanwhile, the transparent substrate 110 may be high-frequency-treated or primer-treated in order to activate the surface thereof. Due to the activation of the surface of the transparent substrate 110, the adhesion between the transparent substrate 110 and the transparent electrodes (first transparent electrode 120 and second transparent electrode 130) is improved.

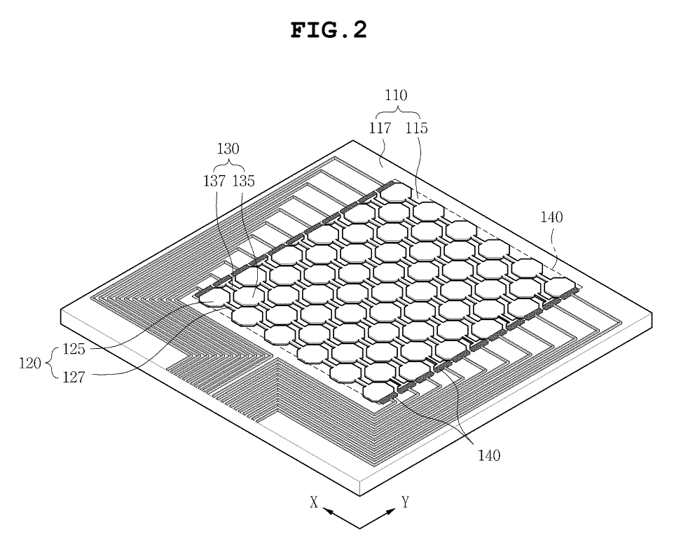

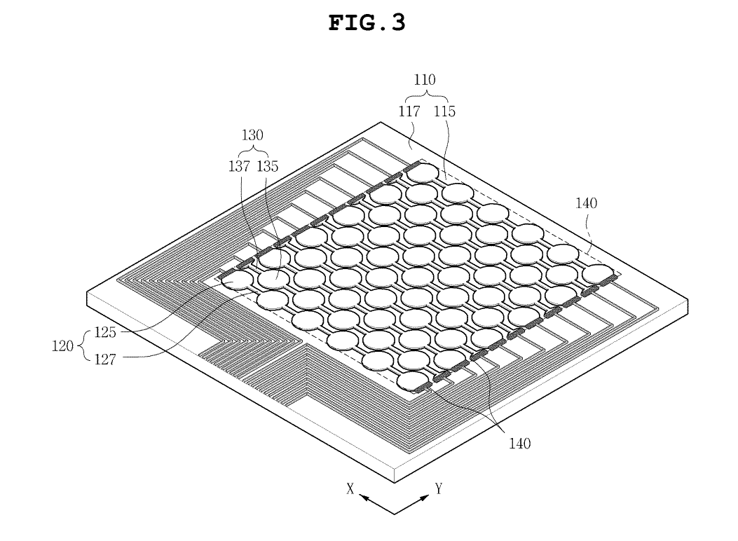

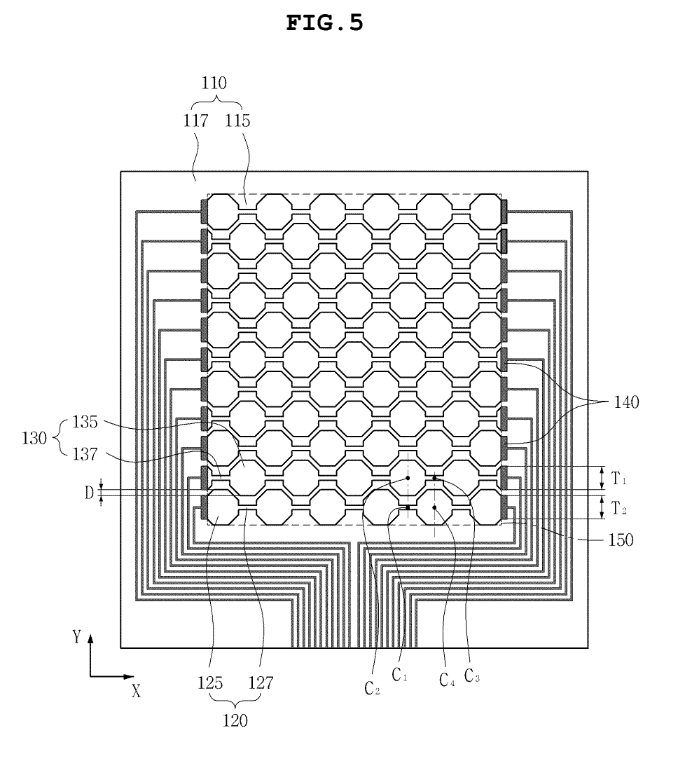

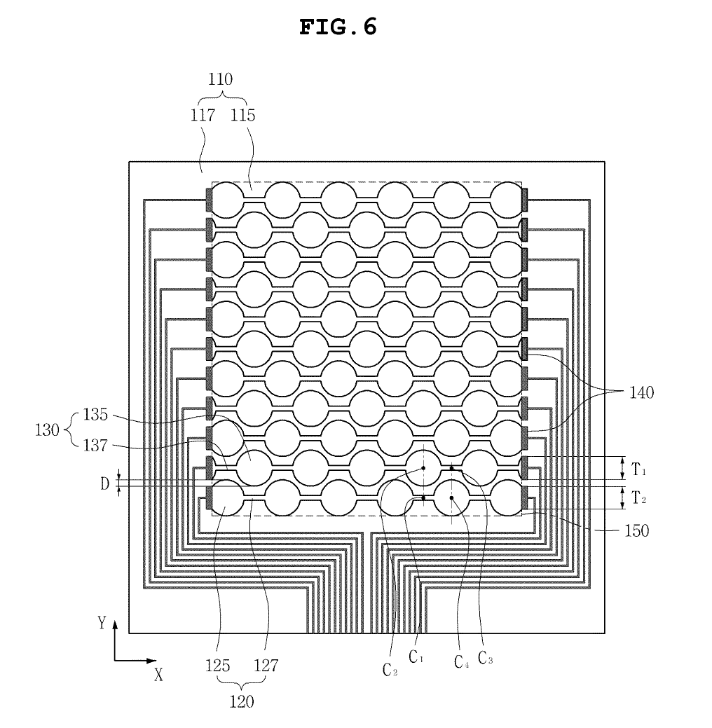

The first transparent electrodes 120, together with the second transparent electrodes 130, which serve to enable a controller to recognize touch coordinates, are plurally formed in the active region 115 of the transparent substrate 110, and are disposed such that they are parallel to each other along the Y-axis direction. Further, each of the first transparent electrodes 120 includes a first sensing unit 125 and a first connecting unit 127. Here, the first sensing unit 125 serves to substantially detect the touch of a user, and the first connecting unit 127 serves to connect the first sensing unit 125 in an X-axis direction. That is, the plurality of first sensing units 125 are disposed at regular intervals along the X-axis direction, and the first connecting unit 127 is disposed between the adjacent two first sensing units 125 to connect the first sensing units 125 to each other, thus aligning the first transparent electrodes 120 in an X-axis direction. Meanwhile, the first sensing units 125 may be formed in various shapes, such as a diamond (refer to FIGS. 1 and 4), an octagon (refer to FIGS. 2 and 5) and a circle (refer to FIGS. 3 and 6).

As described above, the second transparent electrodes 130, together with the first transparent electrodes 120, which serve to enable a controller to recognize touch coordinates, are plurally formed in the active region 115 of the transparent substrate 110 alternately with the first transparent electrodes 120, and are disposed such that they are parallel to each other along the Y-axis direction. Further, each of the second transparent electrodes 130 includes a second sensing unit 135 and a second connecting unit 137. Here, the second sensing unit 135 serves to substantially detect the touch of a user, and the second connecting unit 137 serves to connect the second sensing unit 135 in an X-axis direction. That is, the plurality of second sensing units 135 are disposed at regular intervals along the X-axis direction, and the second connecting unit 137 is disposed between the adjacent two second sensing units 135 to connect the second sensing units 135 to each other, thus aligning the second transparent electrodes 120 in an X-axis direction such that the second transparent electrodes 120 are parallel to the second transparent electrodes 130. Meanwhile, the second sensing units 135, the same as the first sensing units 125, may be formed in various shapes, such as a diamond (refer to FIGS. 1 and 4), an octagon (refer to FIGS. 2 and 5) and a circle (refer to FIGS. 3 and 6). In this case, in order to realize a touch panel having uniform sensitivity, it is preferred that the second sensing units 135 have the same shapes as the first sensing units 125.

As described above, in the touch panel according to the present invention, since the first transparent electrodes 125 and the second transparent electrodes 135 are disposed in parallel to each other along the Y-axis direction and thus does not intersect with each other, bridges are not needed. Therefore, the touch panel according to the present invention is advantageous in that its manufacturing process can be simplified by omitting a process of forming bridges. Further, the touch panel according to the present invention is advantageous in that its visibility can be improved by previously preventing a user from recognizing bridges, and in that noise can be reduced by removing parasitic capacitance generated between the bridges.

Meanwhile, referring to the structural relationship between the first transparent electrode 120 and the second transparent electrode 130, it can be seen that the second sensing unit 135 is disposed between the adjacent two first sensing units 125, and that the first sensing unit 125 is disposed between the adjacent two second sensing units 135. More concretely referring to this structural relationship with reference to FIGS. 4 to 6, the coordinate (CO of the center of the first connecting unit 127 on the X-axis is identical with the coordinate (C₂) of the center of the second sensing unit 135 adjacent to the first connecting unit 127, and the coordinate (C₃) of the center of the second connecting unit 137 on the X-axis is identical with the coordinate (C₄) of the center of the first sensing unit 125 adjacent to the second connecting unit 137. Here, the meaning “identical with” does not mean “mathematically completely identical with” but means that “slight center change” attributable to processing errors occurring in the process of manufacturing the touch panel is allowed. Further, the first sensing unit 125 overlaps with the second sensing unit 135 adjacent to the first sensing unit 125 by predetermined distance (D) base on the Y-axis direction. According to the structural relationship between the first transparent electrode 120 and the second transparent electrode 130, the area ratio of the transparent electrodes (first transparent electrodes 120 and second transparent electrodes 130) per unit area in the active region 115 of the transparent substrate 110 can be increased to a maximum extent, thus improving the sensitivity of the touch panel.

Further, it is preferred that the width (T₁) of the first sensing unit 125 and the width (T₂) of the second sensing unit 135, which are taken along the Y-axis edge of the active region 115, be equal to each other. The advantages thereof will be described later.

Meanwhile, the first transparent electrodes 120 and the second transparent electrodes 130 may be formed using a dry process such as sputtering, evaporation or the like, a wet process such as dip coating, spin coating, roll coating, spray coating or the like, or a direct patterning process such as screen printing, gravure printing, ink-jet printing or the like. Here, the first transparent electrodes 120 and the second transparent electrodes 130 may be made of a conductive polymer having excellent flexibility and coatability as well as commonly-used indium tin oxide (ITO). The conductive polymer may include poly-3,4-ethylenedioxythiophene/polystyrenesulfonate (PEDOT/PSS), polyaniline, polyacetylene, polyphenylenevinylene, and the like.

The electrode wirings 140, which serve to receive electrical signals from the first transparent electrodes 120 and the second transparent electrodes 130, are formed in the bezel region 117 of the transparent substrate 120 and are connected to the terminals of the first transparent electrodes 120 and the terminals of the second transparent electrodes 130, respectively. As described above, since the width (T₁) of the first sensing unit 125 and the width (T₂) of the second sensing unit 135, which are taken along the Y-axis edge of the active region 115, are equal to each other, the contact area between the terminal of the first transparent electrode 120 and the electrode wiring 140 becomes equal to the contact area between the terminal of the second transparent electrode 130 and the electrode wiring 140. Therefore, all the resistances between the transparent electrodes (first transparent electrodes 120 and second transparent electrodes 130) and the electrode wirings can be maintained constant, thus improving the performance of the touch panel.

Meanwhile, the electrode wirings 140 may be printed by silk screening, gravure printing, ink-jet printing or the like. In this case, the electrode wirings 140 may be made of silver paste or organic silver having high electrical conductivity, but the present invention is not limited thereto. That is, electrode wirings 140 may also be made of conductive polymers, metal oxides such as ITO, or low-resistance metals. Meanwhile, it is shown in the drawings that each of the electrode wirings 140 is connected to both ends of each of the transparent electrodes (first transparent electrodes 120 and second transparent electrodes 130), which is set forth to illustrate the present invention, but may be connected to only one end thereof.

As described above, the touch panel according to the present invention is advantageous in that, since the first transparent electrodes and the second transparent electrodes are disposed in parallel to each other, bridges are not needed even though they are flush with each other, thereby simplifying the process of manufacturing the touch panel process.

Further, the touch panel according to the present invention is advantageous in that its visibility can be improved by previously preventing a user from recognizing bridges, and in that noise can be reduced by removing parasitic capacitance generated between the bridges.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A touch panel, comprising:
a transparent substrate including an active region and a bezel region partitioned thereon;
a plurality of first transparent electrodes formed in the active region in parallel to each other along a Y-axis direction and including a plurality of first sensing units and a plurality of first connecting units connected with the plurality of first sensing units in an X-axis direction;
a plurality of second transparent electrodes alternately formed with the plurality of first sensing units in the active region in parallel to each other along the Y-axis direction and including a plurality of second sensing units and a plurality of second connecting units connected with the plurality of first sensing units in the X-axis direction; and
electrode wirings formed in the bezel region and connected to terminals of the first transparent electrodes and terminals of the second transparent electrodes, respectively,
wherein the coordinate of the center of the first connecting unit on the X-axis is identical with the coordinate of the center of the second sensing unit adjacent to the first connecting unit, and the coordinate of the center of the second connecting unit on the X-axis is identical with the coordinate of the center of the first sensing unit adjacent to the second connecting unit.

2. The touch panel according to claim 1, wherein the width of the first sensing unit and the width of the second sensing unit, which are taken along a Y-axis edge of the active region, are equal to each other.

3. The touch panel according to claim 2, wherein the contact area between the terminal of the first transparent electrode and the electrode wiring is equal to the contact area between the terminal of the second transparent electrode and the electrode wiring.

4. The touch panel according to claim 1, wherein the first sensing unit or the second sensing unit has a diamond shape, an octagon shape or a circular shape.

5. The touch panel according to claim 1, wherein the first sensing unit overlaps with the second sensing unit adjacent to the first sensing unit base on the Y-axis direction.

6. The touch panel according to claim 1, wherein the first transparent electrode or the second transparent electrode is made of a conductive polymer.

7. The touch panel according to claim 6, wherein the conductive polymer includes poly-3,4-ethylenedioxythiophene/polystyrenesulfonate (PEDOT/PSS), polyaniline, polyacetylene, and polyphenylenevinylene.
